(19) United States
(12) Patent Application Publication
(10) Pub. No.: US 2025/0237304 A1
(43) Pub. Date: Jul. 24, 2025

(54) TRANSMISSION FOR A VEHICLE

(71) Applicant: TEAM Industries, Inc., Bagley, MN (US)

(72) Inventors: Alexander C. Yudell, Bemidji, MN (US); Thomas Richard Rosenbush, Bagley, MN (US); Gregory Lee Maki, Solway, MN (US)

(73) Assignee: TEAM Industries, Inc., Bagley, MN (US)

(21) Appl. No.: 19/035,300

(22) Filed: Jan. 23, 2025

Related U.S. Application Data
(60) Provisional application No. 63/624,166, filed on Jan. 23, 2024.

(51) Int. Cl. F16H 61/04

(52) U.S. Cl. CPC F16H 61/04; F16H 2061/0422; F16H 2061/0474

(57) ABSTRACT

A transmission for a vehicle that includes a first engagement member, a second engagement member, and shift actuator is provided. The first engagement member is configured to selectively couple torque between a prime mover and an output through a first gear. The second engagement member is configured to selectively couple the torque between the prime mover and the output through a second gear. The shift actuator configured to selectively activate the first engagement member and the second engagement member.

### CROSS-REFERENCE TO RELATED APPLICATIONS

This Application claims priority to U.S. Provisional Application Ser. No. 63/624,166, titled Transmission for Electrical Vehicles, filed on Jan. 23, 2024, which is incorporated in its entirety herein by reference.

### BACKGROUND

Electric motors used in electric vehicles (EVs) have some advantages over internal combustion engines (ICEs). For example, electric motors may have a higher peak torque at a given power rating compared to ICEs. Due to the high peak torque, on road EVs are able to use single speed transmissions since they provide adequate acceleration when geared for an adequate top speed. Electric motors also have the ability to deliver peak torque at zero revolutions per minute (rpm). This also provides an advantage over ICEs, because being able to deliver peak torque at zero rpm eliminates the need for a launch device. Hence the motor does not need to be disconnected from its associated driveline when the vehicle comes to a stop as a vehicle with an ICE is required. Further, another advantage of electric motors is that they can generate both positive and negative torque as well as positive and negative speed. Since electric motors can generate negative torque (reverse torque) and negative speed (reverse speed), there is no need for a separate reverse power path that switches direction of rotation as is required in an ICE transmission configuration. The electric motor may be simply operated in the reverse direction while connected to a common drive path.

Electric motors generally have two operating conditions that depend on the rotational operating speed of the motor. The operating conditions include a constant torque condition and a constant power condition. A rated speed is a motor speed at which transition between the two conditions occurs. From zero speed to the rated speed is a constant torque zone. In the constant torque condition, peak torque or near peak torque is available. From the rated speed to the maximum operating speed is the constant power condition. In the constant power condition, peak or near peak power is provided. The lower the rated speed, the higher the peak torque for a given power rating. Lower rated speed requires physically larger motors which may add mass and cost. Electric motors with higher rated speed may produce the same power but at lower peak torque levels therein requiring a higher speed, but lower mass to reach peak power.

Referring to FIG. 1, a torque and power versus speed graph 100 of a representative electric motor is illustrated. The torque and power versus speed graph 100 includes a torque curve 102 and a power curve 104 that is provided by an electric motor for a given vehicle speed and motor speed. As illustrated in this example, 4000 rpm is the rated speed. There is a linear power increase and constant torque when the motor is below 4000 rpms and a torque decrease and constant power above 4000 rpms. This example motor has a high rated speed relative to many electric motors in the EV space. For a given vehicle mass, torque defines gradeability (the ability to hold or climb on steep terrain) while power defines the acceleration at a given speed.

Although the typical single speed transmission used in EVs provides adequate performance for an EV in on-road applications, in off-road applications a single speed transmission has limitations. On-road EV's typically have a more limited range of torque and power requirements, due to the fact that they operate on relatively level and hard road surfaces. The narrower range of operating conditions lends itself well to a single speed transmission, where the demand torque at the wheels is not varied. In the off road operating environment, there is an expectation for vehicles to have the capability of hauling heavy trailered loads as well as operate high unladen speeds. Moreover, off-road vehicles typically have strenuous trailering and gradeability requirements. Even the high relative torque available in electric motors at typical power ratings cannot deliver the torque needed to meet the gradeability requirements when the driveline is geared to accomplish typical top speed goals. Again, that may not be an issue for light passenger on-road EVs but it may be an issue for off road vehicles such as side-by-sides, ATVs, etc. as well as marine, lawn/garden, motorcycle and snow vehicle applications. More powerful motors are always an option to accomplish torque/power goals with a single speed driveline but require a significant cost compromise.

For the reasons stated above and for other reasons stated below which will become apparent to those skilled in the art upon reading and understanding the present specification, there is a need in the art for a transmission system for off-road vehicles, including EVs.

### SUMMARY OF INVENTION

The following summary is made by way of example and not by way of limitation. It is merely provided to aid the reader in understanding some of the aspects of the subject matter described. Embodiments provide a transmission with a first engaging member and a second engaging member to selectively route motor torque between a prime mover and an output.

In one example, a transmission for a vehicle that includes a first engagement member, a second engagement member, and shift actuator is provided. The first engagement member is configured to selectively couple torque between a prime mover and an output through a first gear. The second engagement member is configured to selectively couple the torque between the prime mover and the output through a second gear. The shift actuator configured to selectively activate the first engagement member and the second engagement member.

In another example, a vehicle that includes at least one electric motor to generate torque, a transmission and a shift actuator is provided. The transmission is in operational communication with the electric motor. The transmission is located between the at least one electric motor and an axle. The transmission includes a first engagement member, a second engagement member and shift actuator. The first engagement member is configured to selectively couple torque between the electric motor and an output through a first gear. The second engagement member is configured to selectively couple the torque between the electric motor and the output through a second gear. The shift actuator is configured to selectively activate the first engagement member and the second engagement member.

In yet another embodiment, a method of changing a gear in a transmission while the vehicle is user way is provided. The method includes dropping a motor torque to zero; removing a first driving dog from engagement; changing the speed of a prime mover to synchronize the speed of one of the first driving dog and a second driving dog to the speed of a selected driven dog; moving one of the first driving dog and the second driving dog into engagement with the selected driven dog; and applying motor torque through one of the first driving dog and the second driving dog.

### BRIEF DESCRIPTION OF THE DRAWINGS

The present invention can be more easily understood and further advantages and uses thereof will be more readily apparent, when considered in view of the detailed description and the following figures in which:

FIG. 1 illustrates a torque versus power graph of the prior art;

FIG. 2A illustrates a schematic diagram of a shaft example of a sprag/active clutch transmission according to one exemplary embodiment;

FIG. 2B illustrates a schematic diagram of another shaft example of a sprag/active clutch transmission according to one exemplary embodiment;

FIG. 2C illustrates a schematic diagram of an epicyclical example of a sprag/active clutch transmission according to one exemplary embodiment;

FIG. 2D illustrates an upshift flow diagram of a transmission according to one exemplary embodiment.

FIG. 2E illustrates a downshift flow diagram of a transmission according to one exemplary embodiment.

FIG. 2F illustrates a regeneration flow diagram of a transmission according to one exemplary embodiment.

FIG. 2G illustrates an engine braking flow diagram of a transmission according to one exemplary embodiment.

FIG. 3A illustrates a schematic diagram of a shaft example of a dog/active clutch transmission according to one exemplary embodiment;

FIG. 3B illustrates a schematic diagram of a shaft example of a dog/active clutch transmission according to one exemplary embodiment;

FIG. 3C illustrates a schematic diagram of an epicyclical example of a dog/active clutch transmission according to one exemplary embodiment;

FIG. 4A illustrates a schematic diagram of a shaft example of a sprag/centrifugal clutch transmission according to one exemplary embodiment;

FIG. 4B illustrates a schematic diagram of another shaft example of a sprag/centrifugal clutch transmission according to one exemplary embodiment;

FIG. 4C illustrates a schematic diagram of an epicyclical example of a sprag/centrifugal clutch transmission according to one exemplary embodiment;

FIG. 5A illustrates a schematic diagram of a shaft example of a dual active clutch transmission according to one exemplary embodiment;

FIG. 5B illustrates a schematic diagram of another shaft example of a dual active clutch transmission according to one exemplary embodiment;

FIG. 5C illustrates a schematic diagram of an epicyclical example of a dual active clutch transmission according to one exemplary embodiment;

FIG. 6A illustrates a schematic diagram of a shaft example of a dog/dog transmission according to one exemplary embodiment;

FIG. 6B illustrates a schematic diagram of a shaft example of a dog/dog transmission according to one exemplary embodiment;

FIG. 6C illustrates a schematic diagram of an epicyclical example of a dog/dog transmission according to one exemplary embodiment;

FIG. 7 illustrates a transmission shift flow time diagram according to one exemplary embodiment;

FIG. 8 illustrates drive cycle energy graph according to one exemplary embodiment;

FIG. 9 illustrates a Geneva wheel actuator shifting system according to one exemplary embodiment;

FIG. 10 illustrates a rotary actuated shift drum actuator shifting system according to one exemplary embodiment;

FIG. 11 illustrates a linear actuated ratchet shift actuator shifting system according to one exemplary embodiment;

FIG. 12 illustrates a rotary actuated ratchet shift actuator shifting system according to one exemplary embodiment;

FIG. 13 illustrates a shift rail actuator shifting system according to one exemplary embodiment; and

FIG. 14 illustrates a block diagram of a vehicle according to one exemplary embodiment.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a multispeed transmission, and in one example, a two-speed transmission that provides relatively high top speed, trailering capacity up steep grades and high acceleration rates that convey a sporty feel. The use of a multispeed transmission in vehicles, including electronic vehicles (EVs), further provides both gradeability and top speed as well as provides peak power at lower speed with a lower gear to improve acceleration. Efficiency gains may also be provided by using the gears to manipulate motor speed to the most efficient operating speed. Also, multispeed EV's may provide the benefit of shifting while underway to maintain sporty acceleration at low vehicle speed while still being able to achieve a desired top speed target. Although, embodiments may be discussed as applying to EVs application, the described transmission may be applied to any type of prime mover that is used to generate driving torque (engine torque) that is used to power a vehicle.

Some examples use an electronic control to shift between gears in the multi speed transmission. Benefits of the use of an electronic control includes having a transmission control unit decide when to shift. In this embodiment, no user input may be needed to get the correct gear and the electronic control can be developed to optimize motor/power electronics efficiency that may maximize range. Other embodiments may allow a user to manually change the gear via hand or foot lever. In at least one example, a fully manual shift is provided that does not use any electronics.

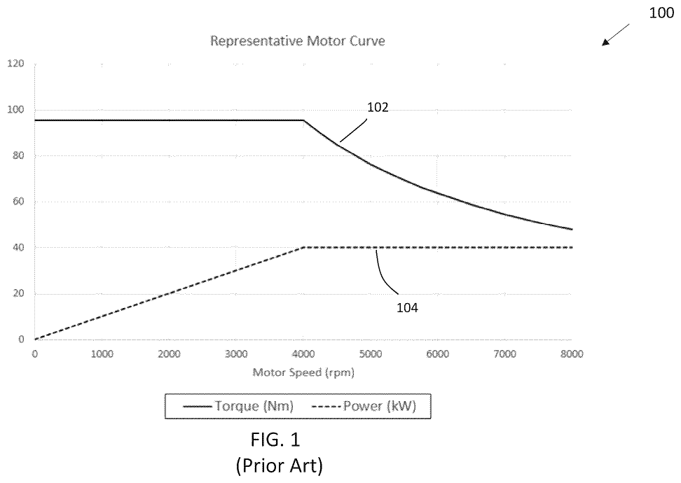

As discussed above, in one example, a two-speed transmission is used. The benefits of a two-speed transmission include allowing for a large gear step. Since electric motors develop peak power over a wide rpm range it allows for a large gear step without sacrificing vehicle acceleration. For example, as illustrated in FIG. 1, the electric motor can go from 8000 rpm to 4000 rpm and still provide the same power and thus vehicle acceleration. Additionally, a tall low gear may be used since electric motors develop high torque at low rpms. The combination of these factors allows comparable performance of a two-speed EV to a similarly powered ICE where four plus gears are required. Further, a two-speed transmission provides a cost-effective transmission with a simple configuration.

One example embodiment uses a dog/dog configuration to shift gears and another example embodiment uses a clutched configuration. The benefits of a dog/dog configuration are that it is simple and robust. A dog/dog configuration requires a torque interruption when shifting between gears. A clutch configuration allows for no torque interruption during gear shifts but is more costly and certain architectures will not allow for engine braking in low gear.

Embodiments of the transmission use both shaft and epicyclical configurations. The epicyclical configuration may be accomplished with either a simple planetary arrangement shown below, or with compound planet gears (that may allow for a wider range of ratios), depending on ratio and space constraints.

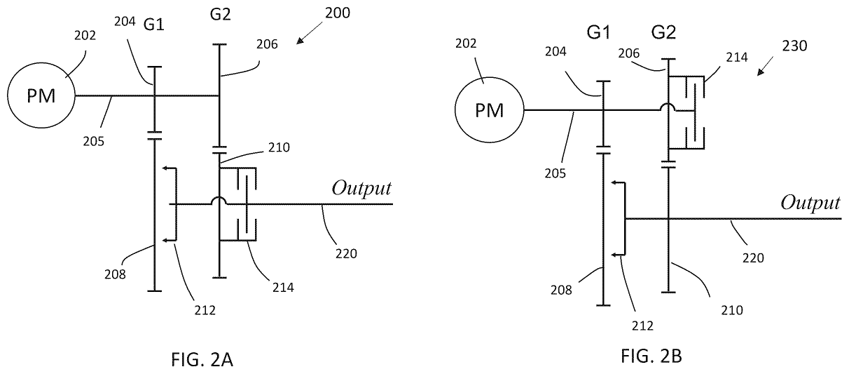

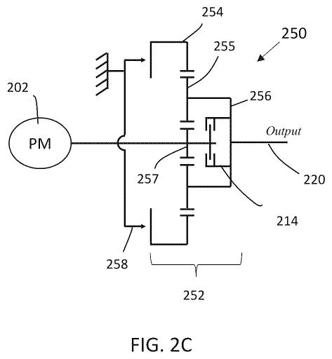

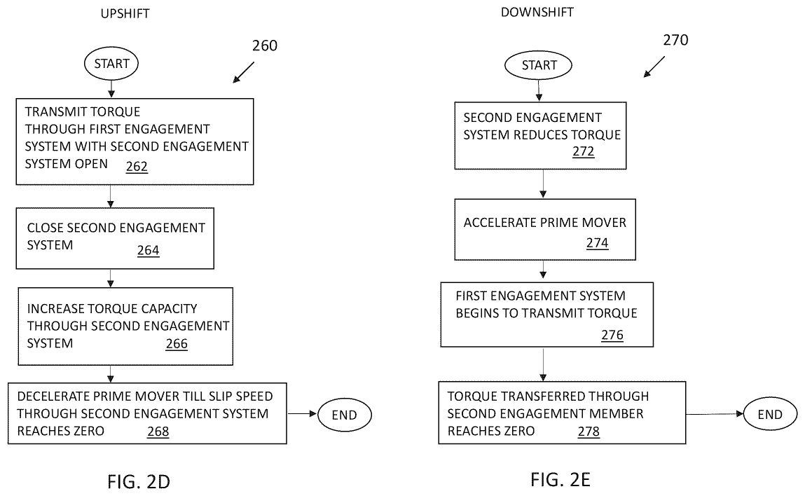

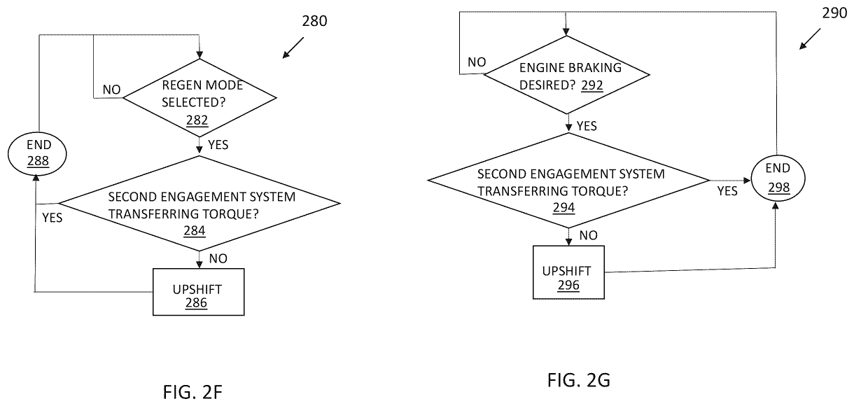

FIGS. 2A and 2B illustrate schematic diagrams of transmission 200 and transmission 230 of example embodiments. The transmissions 200 and 230 are in a parallel axis configuration with sprag/active clutch engagement members in these examples. In the shaft example of the transmission 200 (sprag/active transmission) in FIG. 2A, a prime mover 202 is in operational communication with a first or low input gear 204 (G1) and a second or high input gear 206 (G2). The low input gear 204 is in rotational communication with a low output gear 208 and the high input gear 206 is in rotational communication with a high output gear 210. The low output gear 208 is selectively coupled to an output shaft 220 via first engagement member, which is a sprag clutch 212 (or sprag) in an example. The high output gear 210 is selectively coupled to the output shaft 220 via second engagement member, which includes clutch 214 in this example. In one embodiment clutch 214 is a plate clutch. In another embodiment, clutch 214 is a band clutch. Sprag clutch 212 transmits torque in a first direction while it free spins in a second direction. In the example of FIG. 2A, a clutch basket of clutch 214 is illustrated as being connected to high output gear 210. In another example, the clutch basket of clutch 214 is attached to the output shaft 220. The prime mover 202 may be any type of motor or engine that is capable of generating engine or motor torque that may be used to move a vehicle. Examples of prime movers include, but are not limited to, electric motors, internal combustion engines, hydrogen based motors, etc.

Sprag clutch 212 is located on the driven side of first gear 204 and is oriented to transmit positive (front driving) torque (motor torque) from prime mover 202. When the transmission 200 is in the first gear 204 (G1), the clutch 214 on second gear 206 (G2) is in an open state. The clutch 214 may be located on the drive or driven side of second gear 206 in embodiments. The gears 204 and 206 may be manually selected or may be automatically selected by a controller such as, but not limited to, a transmission control unit.

During an upshift, prime mover 202 transmits torque through sprag clutch 212 with the plate clutch 214 open. When plate clutch 214 begins to close, torque is simultaneously transmitted between the G1 and G2 power paths. Plate clutch 214 continues to increase in torque capacity to the point at which it is transmitting 100 percent of the motor torque. At this point, plate clutch 214 is slipping, but G2 is the sole power path. Plate clutch 214 further increases in torque capacity, greater than 100 percent of motor production. This negative net torque on the motor causes prime mover 202 to decelerate. While prime mover 202 is decelerating, slip speed at clutch 214 decreases to the point where it reaches zero. When slip speed reaches zero, prime mover 202 is synchronized to the second gear speed.

FIG. 2D illustrates a method of upshifting in a transmission, such as but not limited to, transmissions 200 and 230 discussed above. The upshift flow diagram 260 of FIG. 2D is provided in a series of sequential blocks. The sequence of blocks may occur in a different order or even in parallel in other examples. Hence, the present invention is not limited to the sequence set out in upshift flow diagram 260.

The upshift flow diagram 260 begins a block 262 where torque is being transmitted through the first engagement member with the second engagement member being open or not transferring torque. An example of the first engagement member is sprag clutch 212 and a second engagement member is plate clutch 214 discussed above, although other types of engagement members may be used. The second engagement member is then closed or engaged to transfer torque at block 264. The second engagement member increases torque transfer at block 266. The prime mover decelerates in response the increase in transfer of torque through the second engagement member at block 268 until a slip speed through the second engagement member reaches zero and the process ends.

Referring back to FIGS. 2A and 2B, during a downshift, plate clutch 214 on G2 is closed, and is the sole power path. The sprag clutch 212 is overrunning and transmitting zero torque. The G2 clutch 214 reduces torque carrying capacity below 100 percent of motor production. The positive net torque on prime mover 202 causes prime mover 202 to accelerate. When prime mover 202 reaches G1 synchronized speed, the sprag clutch 212 begins to transmit torque. At this time, there is a dual power path between the G1 sprag clutch 212 and the slipping G2 clutch 214. Clutch 214 continuously reduces torque capacity, smoothly transferring all motor torque to the G1 power path.

FIG. 2E illustrates a method of downshifting a transmission, such as but not limited to, transmissions 200 and 230 discussed above. The downshift flow diagram 270 of FIG. 2E is provided in a series of sequential blocks. The sequence of blocks may occur in a different order or even in parallel in other examples. Hence, the present invention is not limited to the sequence set out in upshift flow diagram 270.

The downshift flow diagram 270 begins a block 272 where the second engagement member reduces torque transfer. The prime mover may accelerate at block 274. When the first engagement member begins to transfer torque at block 276. When the prime mover reaches synchronized speed of first engagement member, torque transferred through the second engagement member reaches zero at block 278 and the process ends.

In an EV example, a regeneration mode (REGEN), where energy is provided back to batteries operating the EV, is accomplished via the G2 power path in the sprag/active clutch transmissions 200, 230, and 250 (discussed below), since the sprag clutch 212 on G1 is not capable of transmitting back-driving torque. If REGEN is required while operating in G1, an upshift to G2 would necessarily occur. When forward driving is resumed, the vehicle may downshift back to G1. The same issue is encountered when engine braking is desired since the sprag clutch 212 only transfers torque in one direction. In this situation, once a control unit detects an engine braking situation, an upshift to G2 is provided via clutch 214 to lock up a torque path between the output (driven shaft 220) and the prime mover 202. Hence, both the REGEN and engine braking are accomplished in the same manner in this example embodiment.

An example of a method of placing a transmission into a configuration for regeneration is illustrated in the REGEN flow diagram 280 of FIG. 2F. The REGEN flow diagram 280 of FIG. 2F is provided in a series of sequential blocks. The sequence of blocks may occur in a different order or even in parallel in other examples. Hence, the present invention is not limited to the sequence set out in REGEN flow diagram 280.

The REGEN flow diagram 280, starts at block 282 where it is determined if a REGEN mode has been selected. In one example, a REGEN mode may be selected by a vehicle operator. In another example, a vehicle controller, such as controller 1410 discussed below, may select the REGEN mode based on sensor signals outputs from sensors, such as sensors 1412-1 through 1412-n discussed below and stored operating instructions. The REGEN flow diagram may be used with the transmissions 200 and 230 discussed above.

If it is determined that a REGEN mode has been selected, it is then determined if the second engagement member is currently transferring toque. In this example, REGEN is accomplished through the second power path G2 which includes the second engagement member. If it is determined that the second engagement member is transferring torque at block 284, the process ends at block 288 since the transmission is in the correct configuration for REGEN. If, however, it is determined at block 284, the second engagement member is not transferring torque, the transmission is upshifted, as described above, at block 286. The process then ends at block 288 until another REGEN mode is selected at block 282.

An example of a method of placing a transmission into a configuration for engine braking is illustrated in the engine flow diagram 290 of FIG. 2G. The engine braking flow diagram 290 of FIG. 2G is provided in a series of sequential blocks. The sequence of blocks may occur in a different order or even in parallel in other examples. Hence, the present invention is not limited to the sequence set out in engine flow diagram 290.

The engine braking flow diagram 290, starts at block 292 where it is determined if engine braking is desired. In one example, a vehicle controller, such as controller 1410 discussed below, my desire engine braking based on sensor signals outputs from sensors, such as sensors 1412-1 through 1412-n discussed below and stored operating instructions.

If it is determined that engine braking is desired, it is then determined if the second engagement member is currently transferring torque. In this example, engine braking is accomplished through the second power path G2 which includes the second engagement member. If it is determined that the second engagement member is transferring torque at block 294, the process ends at block 298 since the transmission is in the correct configuration for engine braking. If, however, it is determined at block 294, the second engagement member is not transferring torque, the transmission is upshifted, as described above, at block 296. The process then ends at block 298 until it is again determined at block 292 that engine braking is desired.

In view of the transmissions 200 and 230 of FIG. 2A and 2B, if a user does not wish to experience shifts and does not have a need for high axle torque, the G2 clutch 214 may remain continuously locked as a selectable setting. In another embodiment, the vehicle could use G2 as the default gear, with the control unit only engaging G1 in periods of high torque demand from the user.

The coupling to accomplish shifting of the transmission may occur on either the drive shaft 205 (input shaft), driven shaft 220 (output shaft) an intermediate shaft, or a combination of shafts. In the example of FIG. 2A, the coupling occurs on the driven shaft 220. An example of coupling on the drive shaft 205 is illustrated in the sprag/active clutch transmission 230 of FIG. 2B. As illustrated, in this example, clutch 214 selectively engages the drive shaft 205 to G2 (the second gear 206).

The transmission 250 in an epicyclical configuration example, illustrated in FIG. 2C, operates in a similar way, as described above with regards to transmissions 200 and 230 with the use of a sprag clutch 258. In this example, a planetary gear set or epicyclic gear train 252 is used instead of G1 and G2 discussed above to communicate torque between prime mover 202 and the output (driven shaft 220). The epicyclic gear train 252 in this example includes a ring gear 254, a planetary gear 255, a planetary carrier 256 and a sun gear 257. Hence other types of transmission with sprag/active clutch engagement members may be used.

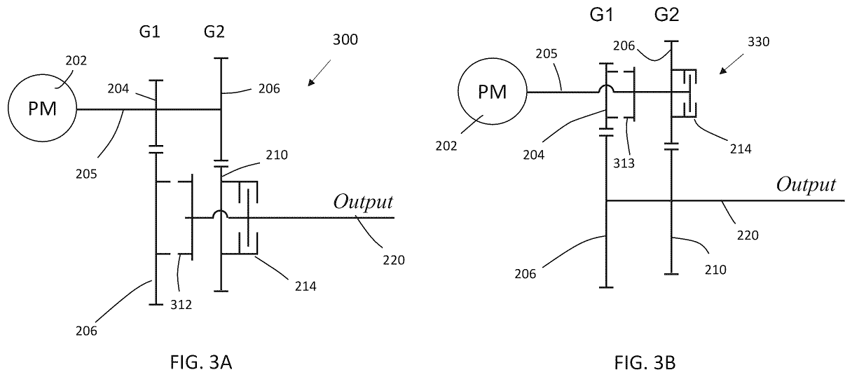

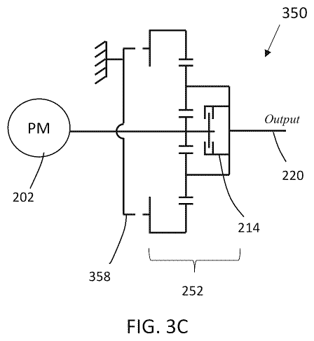

FIGS. 3A and 3B illustrate transmissions 300 and 330 using a dog as a first engagement member and an active clutch as a second engagement member in a parallel axis shaft configuration. FIG. 3C illustrates transmission 350 with a dog/active clutch first and second engagement members in an epicyclical configuration respectively. Transmissions 300 and 350 (dog/active clutch transmissions) are similar to transmissions 200 and 250, discussed above, but with the use of a dog 312 in the shaft configuration of FIG. 3A and dog 358 in the epicyclic configuration of FIG. 3C replacing the sprag clutch 212 and 258 respectively. Removing dog 312 or 313 from mesh (disengagement) would require that torque across G1 be near zero to avoid torque bind. Moving dog 312 or 313 into mesh (engagement) would require that speed differential across G1 be near zero. Although this configuration may require a more complicated control algorithm than needed in transmissions 200, 230, or 250, signals provided to the control algorithms may be provided by sensors that are normally fitted to the vehicle motor speed and wheel speed sensors. Motor torque may be controlled directly via motor controller. The advantage to the configurations in FIGS. 3A and 3C is that engine braking or REGEN torque can be transmitted when in a low gear G1 via the respective dogs 312, 313, and 358.

If a user did not wish to experience shifts and did not have a need for high axle torque, the G2 clutch 214 could remain continuously locked as a selectable setting. Alternatively, since in this configuration back driving torque is available in power path G1, the transmission could be locked into G1 as a selectable setting when the user requires high axle torque and not high speed. In another embodiment, the vehicle could use G2 206 as the default gear, with the control unit only engaging G1 204 in periods of high torque demand from the user.

Regarding the shaft configuration, the coupling to accomplish shifting of the transmission may occur on either the drive shaft 205 (input shaft) or driven shaft 220 (output shaft). In the example of FIG. 3A, the coupling occurs on the driven shaft 220. An example of coupling on drive shaft 205 is illustrated in the transmission 330 of FIG. 3B. As illustrated, in this example, clutch 214 selectively engages the drive shaft 205 to G2 (the second gear 206) and dog 313 selectively couples drive shaft 205 to G1 (the first gear 204). Alternate embodiments may have any combination of the dog on input shaft 205 or output shaft 220, and the clutch on input shaft 205 or output shaft 220.

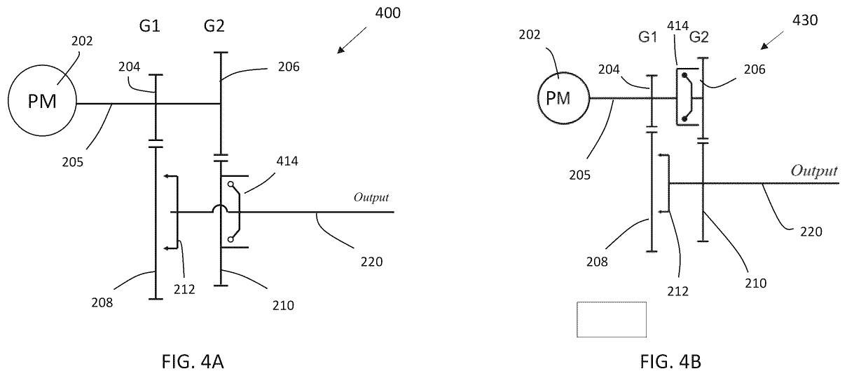

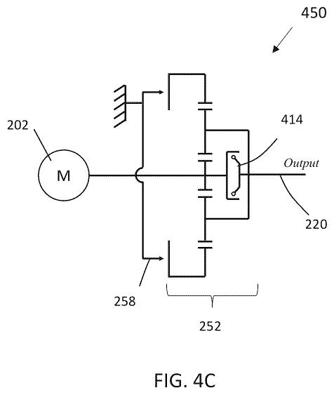

FIGS. 4A and 4B illustrate transmission 400 and transmission 430 in a parallel axis configuration. The first engagement member in these examples is a sprag and the second engagement member is a centrifugal clutch. FIG. 4C illustrates transmission 450 in an epicyclical configuration. The sprag/centrifugal engagement members of transmissions 400 and 450 (sprag/centrifugal transmissions) are similar to sprag/active clutch first and second engagement members of transmissions 200 and 230 but with a centrifugal clutch 414 replacing the active clutch 214 in transmissions 200 and 230. In the example of 400, the clutch flyweights are rotationally fixed to the output shaft 220. In the example of 430, the centrifugal clutch flyweights are rotationally fixed to gear 206. Centrifugal clutch 414 engages above a set output/vehicle speed and transitions the second gear G2 (in the shaft formats) to the primary power path. Below shift speed, the centrifugal clutch 414 disengages and transfers power to the G1 sprag clutch 212. Shift speed is directly related to vehicle ground speed and is mechanically tunable. When the shift speed is exceeded, and the G2 power path is active, the sprag clutch 212 is overrunning and does not transmit torque.

Regarding the shaft configuration, the coupling of the gears to accomplish shifting of the transmission may occur on either the drive shaft 205 (input shaft), driven shaft 220 (output shaft), an intermediate shaft or any combination of the shafts. In the example of FIG. 4A, the coupling occurs on the driven shaft 220. An example of coupling on the drive shaft 205 and the driven shaft 220 is illustrated in the dual active clutch transmission 430 of FIG. 4B. As illustrated, in this example, sprag clutch 212 selectively engages G1 to the driven shaft 220 and the centrifugal clutch 414 selectively couples G2 to the drive shaft 205.

In an embodiment, a mechanical actuation may be employed to modify the preload of the centrifugal weights of the centrifugal clutch 414. Modifying the preload on the weights would allow manipulation of the shift speed while under way.

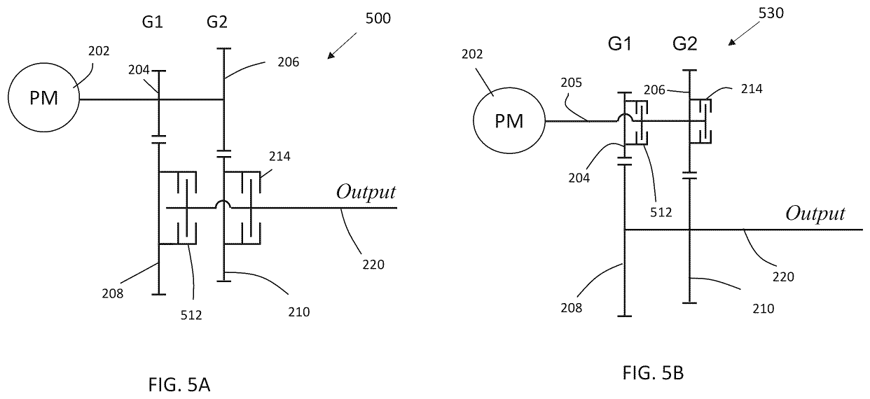

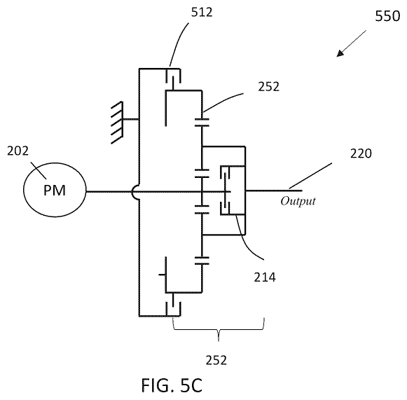

FIGS. 5A and 5B illustrate transmissions 500 and 530 that uses a dual action clutch for the first and second engagement members. Transmissions 500 and 530 (dual active clutch transmissions) in FIGS. 5A and 5B are in a shaft configuration while FIG. 5C illustrates a dual active clutch transmission 550 in an epicyclical configuration. Transmissions 500 and 530 are similar to the sprag/active clutch first and second engagement members of FIG. 2A and 2B but with two controllable active clutches 512 and 214 for the first and second engagement members. This configuration would provide the highest shift quality, but at the compromise of the cost of two active clutches 512 and 214.

This configuration allows for regeneration/back-driving to occur in either G1 or G2 by controlling the respective active clutches 512 and 214. Further if a user did not wish to experience shifts and did not have a need for high axle torque, the G2 clutch 214 could remain continuously locked as a selectable setting. Alternatively, since in this configuration back driving torque is available in power path G1, the clutch 512 could remain locked as a selectable setting when the user requires high axle torque and not high speed. In another embodiment, the vehicle could use G2 as the default gear, with the control unit only engaging G1 in periods of high torque demand from the user.

Regarding the shaft configuration, the coupling to accomplish shifting of the transmission may occur on either the drive shaft 205 (input shaft), driven shaft 220 (output shaft), an intermediate shaft or any combination of the shafts. In the example of FIG. 5A, the coupling occurs on the driven shaft 220. An example of coupling on drive shaft 205 is illustrated in transmission 530 of FIG. 5B. As illustrated, in this example, clutch 214 selectively engages the drive shaft 205 to G2 (the second gear 206) and clutch 512 selectively couples drive shaft 205 to G1 (the first gear 204).

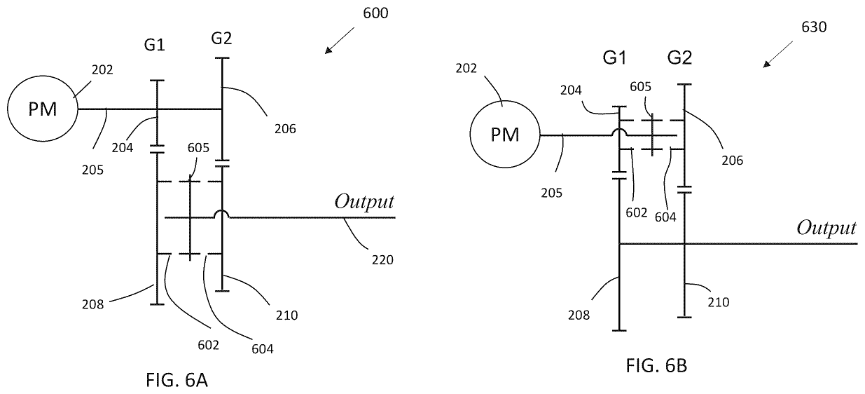

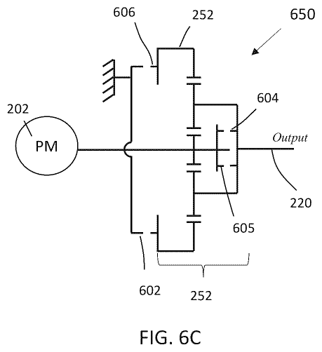

FIGS. 6A and 6B illustrate transmission 600 and transmission 630 (dog/dog transmissions) that use a dog for both the first engagement member and the second engagement member in a parallel axis shaft configuration in an example. FIG. 6C illustrates a dog/dog transmission 650 in an epicyclical configuration. A vehicle may proceed in either G1 or G2 in the parallel axis shaft configuration. When a shift is required, motor torque is dropped to zero, and the active dog 605 is disengaged. While in this neutral state, prime mover 202 is commanded to match the speed of the incoming gear 208 or 210. Once motor speed is synchronized to the incoming gear, dog 605 (driving dog) engages dog teeth on select driven dogs 602 or 604 on respective gears 208 or 210 to engage a selected gear. Dog 605 is rotationally fixed to the driven shaft 220 (output) in this example but is able to translate axially to engage the dog teeth of the select driven dogs 602 and 604. After engagement occurs, motor torque is ramped back up. During the majority of the shift sequence, no torque is transmitted to the ground via the output (driven shaft 220). REGEN and back driving may occur in either G1 or G2 in this example embodiment.

If a user did not wish to experience shifts and did not have a need for high axle torque, the G2 dog 605 may remain continuously locked as a selectable setting. Alternatively, since in this configuration back driving torque is available in power path G1, the dog 605 (driving dog) may remain locked as a selectable setting when the user requires high axle torque and not high speed. In another embodiment, the vehicle could use G2 as the default gear, with the control unit only engaging G1 in periods of high torque demand from the user.

Regarding the shaft configuration, the coupling to accomplish shifting of the transmission may occur on either the drive shaft 205 (input shaft), the driven shaft 220 (output shaft), an intermediate shaft or any combination of the shafts. In another embodiment, the coupling to accomplish power paths G1 and G2 may be on different shafts. In the example of FIG. 6A, the coupling occurs on the driven shaft 220. An example of coupling on drive shaft 205 is illustrated in the dog/dog transmission 630 of FIG. 6B. As illustrated, in this example, the dog 605 (driving dog) selectively engages the drive shaft 205 to either G1 (the first gear 204) or G2 (the second gear 206) by selectively engaging the dog teeth of driven dogs 602 and 604 on respective gears 204 and 206. In the example of the dog/dog transmission 650 with the epicyclic gear train 252 of FIG. 6C, the output shaft 220 selectively changes the gearing via driven dog 602/driving dog 606 and driven dog 604/driving dog 606. That is, in this epicyclic example, a first driving dog 606 selectively engages a first driven dog 602 and a second driving dog 605 selectively engages a second driven dog 604.

FIGS. 3A, 3B, 3C, 4A, 4B, 4C, 5A, 5B, 5C, 6A, 6B, and 6C respectively provide configurations of transmissions 200, 230, 250, 300, 330, 350, 400, 430, 450, 500, 530, 550, 600, 630, 650 of example embodiments. In other examples, inversions of each of the configurations of the transmissions 200, 230, 250, 300, 330, 350, 400, 430, 450, 500, 530, 550, 600, 630, 650 may be used.

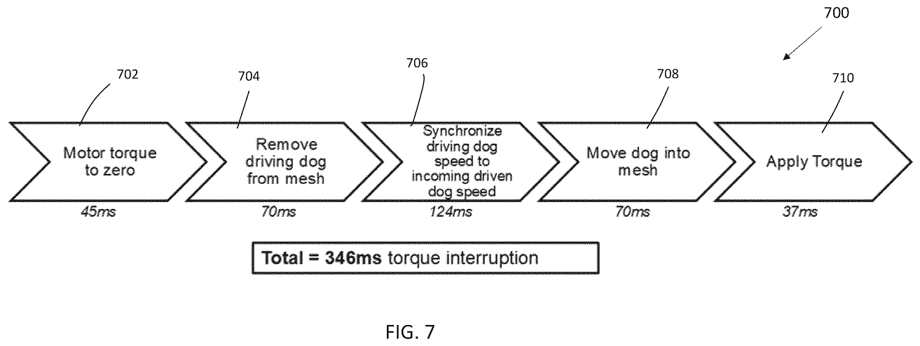

FIG. 7 illustrates a transmission shift sequence time diagram 700 while the vehicle is under way with a dog/dog transmission such as the dog/dog transmission of embodiments illustrated in FIGS. 6A, 6B and 6C. In this example, it is assumed that the motor has a finite rate of torque change, and the time to move dog into or out of mesh is 70 ms.

As illustrated in the transmission shift flow time diagram 700, the process starts in this example at block 702 when the motor torque is dropped to zero which takes 45 ms in this example. Further in an example, this is done with a motor controller, such as motor controller 1410 discussed below. Dog out, where dog teeth of the driving dog 605 are removed from associated dog spaces of dog teeth of one of the driven dogs 602 and 604 (remove driving dog from mesh (disengagement)) occurs at block 704. This takes 70 ms in this example. Removing the driving dog from mesh breaks the torque flow path through the driveline. Motor speed is increased or decreased to synchronize the driving dog speed to the speed of the driven dog 602 or 604 at block 706 which takes 124 ms in an example. This ensures that the dogs mesh at low speed differential, mitigating NVH and wear concerns at the dog interface. The driving dog teeth are mated with the dog spaces of the select driven dog 602 or 604 (dog in) at block 708 which takes 70 ms in this example. Once the engagement location is reached the engagement is near instantaneous. Torque is then ramped back up at block (710) which takes 37 ms in this example. The total time needed to complete the shift in this example is 346 ms. In this example, the dominant time delay in this block is due to the translation time of the driving dog 605. In other examples, the motor rate of torque change may be the dominant time delay. This would represent 264 ms of torque interruption.

Dog actuation may occur via shift rail with a linear actuator, rotary actuator and shift drum, rotary ratcheting mechanism, linear ratcheting mechanism and the like. In the rotary actuator and shift drum example, a closed loop control may be used for the rotary actuator with a sensor on the shift drum to tell the DC motor when to stop. Further a stepper motor may be used. The rotary ratcheting mechanism may index one or more locations per rotation. The linear ratcheting mechanism may index one location per actuation.

Shift dogs may be hard in/hard out or spring in/spring out depending on the actuation method used, or any combination of the two. Spring out dogs allow the dog actuation movement to occur simultaneously with the motor torque drop. Springs become loaded up, and when motor torque drops such that torque bind is released, the dog may rapidly disengage under the force of the preloaded spring.

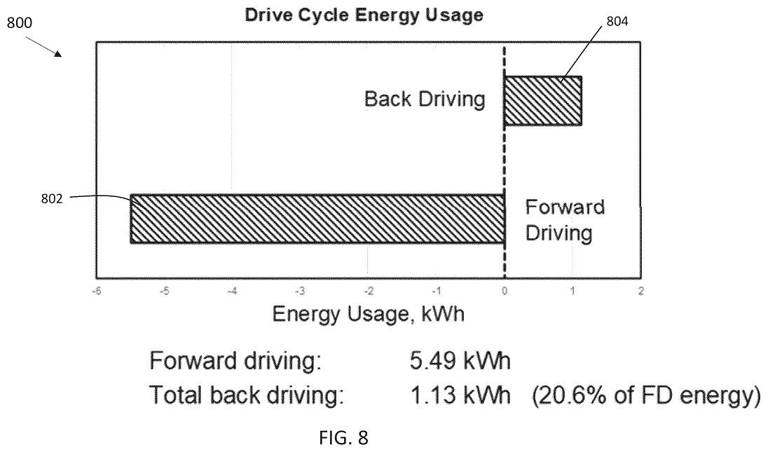

With the use of EVs, battery range is a critical consideration. The use of regeneration (REGEN) techniques to provide some energy back to the batteries extends the battery range therein allowing the vehicle to travel farther without having to recharge. REGEN is available during back driving of the electric motor, which during REGEN acts as a generator. A drive cycle energy graph 800 is illustrated in FIG. 8. The data is provided based on an 18 mile representative off road driving cycle with instrumented axles using torque and speed logging. The graph 800 illustrates the forward driving (positive torque) 802 where energy is taken from batteries of the EV and back driving 804 (engine braking, negative torque) where energy may be provided back to batteries of the EV. As illustrated in FIG. 8, in an ideal system, back-driving would reduce battery capacity requirement by 20.6%.

When the motor applies forward driving power, this power goes two places, to overcome losses and to increase vehicle speed (kinetic energy). Regeneration recovers the kinetic energy when the vehicle decelerates. During regeneration, the motor becomes a generator which converts shaft power to electric power. The electric power is then stored in the battery. Shaft power consumption reduces vehicle kinetic energy and thus vehicle speed.

In ‘single pedal’ driving, REGEN is accomplished by applying back driving torque upon release of a throttle pedal below a threshold. The amount of back driving torque is tunable by either the user or set by the OEM. The driver may modulate the back driving torque by applying slight pedal, at levels below the threshold that initiates back driving. More back driving torque results in more regeneration. The back driving torque may be adjusted by the user via dash knob. Further a user could also use a knob for hill descent control if needed in an example embodiment. In single pedal driving, a pedal to control the service brakes may be present in case a hard braking event was required.

In a two pedal driving EV, back driving torque on coast down is low, similar to existing ICE power trains. Depressing the brake pedal at moderate levels induces back driving torque at the electric motor. Heavy application of the brake pedal engages the service brakes. The two pedal system is more complicated mechanically and programmatically. It requires control system tuning for seamless handoff from REGEN braking to service braking.

REGEN power is penalized twice “Round trip efficiency” which reduces efficiency. A one percent difference in driveline efficiency requires about a 1.6 percent increase in battery capacity, assuming a 20.6 percent back driving ratio and full energy recapture (no service brake usage). It is important to maximize efficiency to reduce battery size, cost for a given range objective.

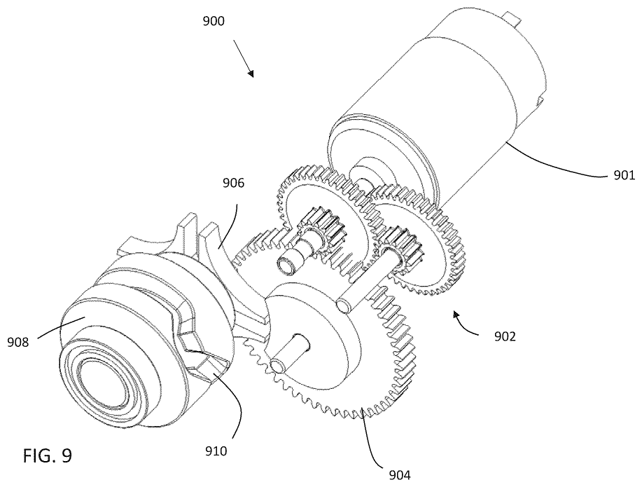

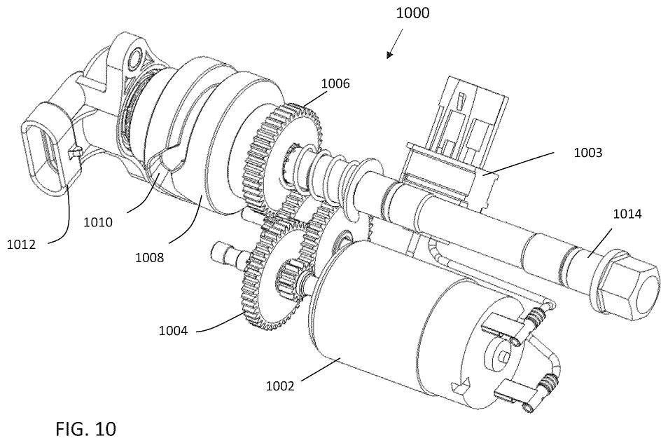

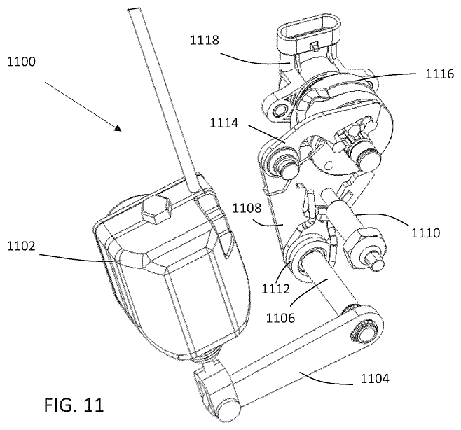

Referring to FIGS. 9 through 13, different example embodiments of a shift actuator are provided. FIG. 9 illustrates a Geneva wheel actuator shifting system 900 of an example embodiment. The Geneva wheel actuator shifting system 900 includes a gear reduction set 902 that is engaged with an electric activation motor 901. The electric motor 901 may be a DC motor or an AC motor or a stepper motor. The gear reduction set 902 is engaged with a drive gear 904 that is in operational communication with a driven gear 906 (which includes a Geneva wheel configuration in this example). The driven gear 906 is coupled to move a shift drum 908. The shift drum 908 includes at least one shift groove 910 that is used to manipulate at least one of a plate clutch and dog of a transmission to switch gears as discussed above. The actuation may be an open loop (no shift drum position sensor) or a closed loop (including a shift drum sensor). In the embodiment, a Geneva wheel with 4 index locations is shown. In other embodiments, there may be a greater or fewer number of index locations.

FIG. 10 illustrates a rotary actuated shift drum actuator shifting system 1000 of an example embodiment. The rotary actuated shift drum actuator shifting system 1000 includes an electric motor 1002 which may be a DC, AC or a stepper motor. A motor electrical connector 1003 is coupled to actuate the motor 1002. An output shaft of the motor 1002 is engaged with a gear reduction set 1004 which in turn is engaged with a driven gear 1006. The driven gear 1006 is coupled to the shift drum 1008 which includes at least one shift groove 1010. This example also illustrates a drum position sensor 1012 that is positioned to sense the position of the shift drum 1008 and hence the gear the transmission is in. As with all embodiments using a shift drum, the drum position sensor 1012 may be located at any point between the electric motor 1002 and the shift drum 1008. This embodiment also includes a manual override device 1014 that allows a user to shift the unit into neutral or into gear in the event of electrical power loss or malfunction.

FIG. 11 illustrates a linear actuated ratchet shift actuator shifting system 1100 of an example embodiment. The linear actuated ratchet shift actuator shifting system 1100 includes a linear actuator 1102. The linear actuator 1102 may be electrically, hydraulically powered or the like. An actuation lever 1104 is operationally coupled to the linear actuator 1102. The actuator level 1104 in turn is operationally coupled with an activation shaft 1106. The activation shaft 1106 is operationally coupled to a pawl lever 1108. A pawl stop device 1110 is positioned to prevent the pawl lever 1108 from rotating beyond a select operational activation rotation. A return spring 1112 is positioned to bias the pawl lever 1108 at a desired orientation when the linear actuator 1102 is not activated. A drum activation pawl 1114 operationally couples the pawl lever 1108 to a shift drum 1116. Further, a drum sensor 1118 is positioned to determine the position of the shift drum 1116. This example embodiment may include detents to hold the shift drum in a relative rotary position.

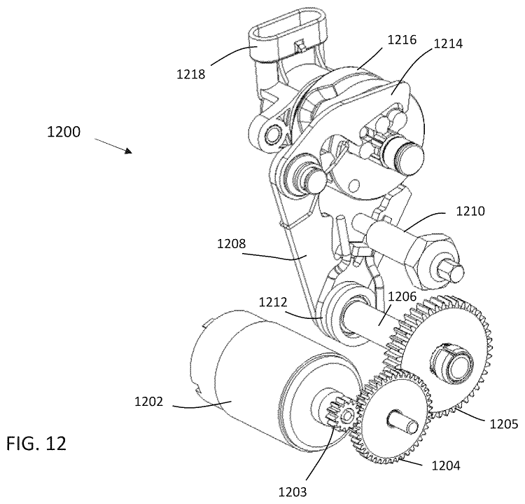

FIG. 12 illustrates a rotary actuated ratchet shift actuator shifting system 1200 of an example embodiment. The rotary actuated ratchet shift actuator shifting system 1200 includes an electric motor 1202. The electric motor may be DC, AC or a stepper motor. A gear set 1203, 1204 and 1205 operationally couples an output of the electric motor 1202 to an activation shaft 1206. The activation shaft 1206 is operationally coupled to a pawl lever 1208. A pawl stop device 1210 is positioned to prevent the pawl lever 1208 from rotating beyond a select operational activation rotation. A return spring 1212 is positioned to bias the pawl lever 1208 at a desired orientation when the motor 1202 is not activated. A drum actuation pawl 1214 operationally couples the pawl lever 1208 to a shift drum 1216. Further, a drum sensor 1218 is positioned to determine the position of the shift drum 1216.

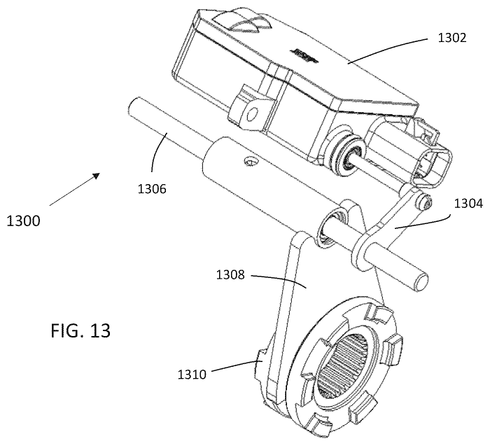

FIG. 13 illustrates a shift rail actuator shifting system 1300 of an example embodiment. The shift rail actuator shifting system 1300 includes a linear actuator 1302 that is operationally coupled to a rail actuation lever 1304. The rail actuation lever in turn is operationally coupled to a shift rail 1306. The shift rail 1306 is operationally coupled to a shift fork 1308. The shift fork 1308 in this example embodiment is operationally coupled to a shift dog 1310. The linear actuator may have two or more positions in this example. A primary path may have three positions, gear one, neutral and gear two. The linear actuator 1302 may be electrically, hydraulically or the like actuated.

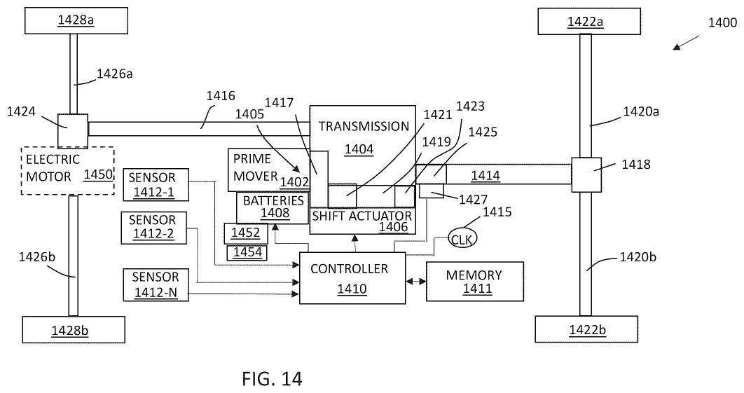

Referring to FIG. 14, a vehicle 1400 that includes a prime mover 1402, a transmission 1404 and a shift actuator 1406 of an example embodiment is illustrated. The transmission 1404 may be any of the transmissions 200, 230, 250, 300, 330, 350, 400, 430, 450, 500, 530, 550, 600, 630, 650 described above. Actuator 1406 may be any of the actuator shifting systems 900, 1000, 1100, 1200, 1300 described above. Also illustrated in FIG. 14 are batteries 1408 that in one example power the prime mover 1402. Prime mover 1402, in this example is an electric motor.

Vehicle 1400 in this Example includes a controller 1410 and a memory 1411. In general, the controller 1410 may include any one or more of a processor, microprocessor, a digital signal processor (DSP), an application specific integrated circuit (ASIC), a field program gate array (FPGA), or equivalent discrete or integrated logic circuitry. In some example embodiments, controller 1410 may include multiple components, such as any combination of one or more microprocessors, one or more controllers, one or more DSPs, one or more ASICs, one or more FPGAs, as well as other discrete or integrated logic circuitry. The functions attributed to the controller 1410 herein may be embodied as software, firmware, hardware or any combination thereof. The controller 1410 may be part of a system controller or a component controller such as but not limited to an engine control module or transmission control module. The memory 1411 may include computer-readable operating instructions that, when executed by the controller 1410 provides functions of the transmission. Such functions may include the functions of shifting as described above as well as other functions described below. The computer readable instructions may be encoded within the memory. Memory 1411 is an appropriate non-transitory storage medium or media including any volatile, nonvolatile, magnetic, optical, or electrical media, such as, but not limited to, a random-access memory (RAM), read-only memory (ROM), non-volatile RAM (NVRAM), electrically-erasable programmable ROM (EEPROM), flash memory, or any other storage medium.

The controller 1410 is in communication with a plurality of sensors 1412-1 through 1412-N. The sensors may generally be referenced by 1412. The sensors 1412-1, 1412-2 through 1412-N may include, but are not limited to, temperature sensors, speed sensors (including wheel speed sensors and transmission speed sensors), throttle sensors, accelerometers, inertial navigation system, gyroscope, global position satellite system, etc. The controller 1410 may use, at least in part, sensor information from at least one sensor 1412 and operating instructions stored in the memory 1411 implemented by the controller 1410, in controlling the shift actuator 1406 to shift the transmission 1404 as well as in controlling other functions of the vehicle 1400.

The vehicle 1400 in this example further includes a rear prop shaft 1414 that is used to communicate torque between the transmission 1404 and rear wheels 1422a and 1422b via rear differential 1418 and rear half shafts 1420a and 1420b (rear axles). Further, a front prop shaft 1416 may be used to communicate torque between the transmission 1404 and front wheels 1428a and 1428b via front differential 1424 and front half shafts 1426a and 1426b (front axles). In another embodiment, transmission 1404 is a transaxle, combining the features of transmission 1404, rear prop shaft 1414 and differential 1418 into a single unit.

An embodiment further includes a hill assist mode. The hill assist mode may be used to prevent rollback. In an example, the vehicle 1400 will detect an incline operation and apply motor torque to counter a downhill force. Detection may be via onboard accelerometers (sensors 1412) or by detecting wheel speed that is asymmetrical to driver input (using wheel speed sensor information and throttle position sensor information for example), or opposite of driver input. Rollback prevention may time out after not detecting driver input, or proceed until thermal conditions prohibit continuation in examples. In one example, the controller 1410 is in communication with a clock 1415 that is used for at least time out functions.

Further embodiments include at least one cooling system. In one example, a three-in-one design that includes a prime mover 1402, transmission 1404 and inverter 1417 all housed in the same case. In one example the prime mover 1402 is an electric motor. Since the electric motor (prime mover 1402) and inverter 1417 may require liquid cooling, transmission oil from a transmission sump of the transmission 1404 may be passed through heat exchanger passages in the prime mover 1402 and/or inverter 1417 to remove heat (i.e. from prime mover 1402 and/or invertor 1417 housed in the same case) in a shared cooling system 1405. The oil may then be passed to an air-to-oil heat exchanger 1419 and rejected to ambient. In another example, a water and/or glycol mixture may be passed through the electric motor (prime mover 1402) and/or inverter 1417 in a similar fashion. The water and/or glycol mixture may be passed to a liquid to air heat exchanger 1419 and rejected to ambient. The water and/or glycol mixture may be contained in a closed loop circuit, isolated from the transmission fluid. Further in another example, the transmission case has fins cast into the geometry of the case to cool internal components by convective heat transfer to the ambient air. The internal components may include one or more of a transmission, an electric motor, and an inverter for the electric motor. In an embodiment, transmission 1404 is a transaxle, which would include differential 1418 along with the motor, inverter and transmission in the common case.

The cooling fluid pump type selected may be dependent on which liquid cooling fluid is to be used. The coolant pump 1421 could be driven by a prime mover in a design that allows the prime mover to spin while at idle. Examples where a prime mover may be used is in dog, sprag and clutch configurations. With the prime mover spinning at idle, the cooling fluid is able to circulate at zero vehicle speed. In another embodiment, a separate electric cooling pump may be used to circulate the coolant fluid. The pump speed may be set independent of the prime mover speed.

Waste heat from the transmission 1404, the prime mover 1402 and inverter 1417 may be used for a beneficial purpose such as, but not limited to, heating the cabin and/or the battery 1408 of the vehicle 1400. A liquid to air heat exchanger (heater core 1423) may be employed in series with the cooling circuit. Air blown across this heater core 1423 would be used to warm the cabin. Batteries have reduced performance in very cold weather. Waste heat from the system could be used to warm the batteries 1408 to improve performance. This heat could come from the liquid cooling circuit, or the rejected warm air from the liquid to air cooler (i.e., the air-to-oil heat exchanger 1419). The heater core 1423 may be a separate heater core. The heater core in an example may also be air coming from a main heat exchanger.

Further in an example, an electromagnetic coil 1427 may be used to apply clamp force to a clutch pack 1425 in an active torque management (ATM) system. The clutch pack 1425 would be located somewhere downstream of the prime mover 1402, but likely downstream of the transmission 1404 in an example and upstream of the axles (rear and front half shafts 1420a, 1420b, 1426a and 1426b. Control of the clamp force may be active, tracing at some fraction above the transmitted torque. Since clutch coil power consumption may be proportional to transmitted torque, the use of an active control system minimizes power consumption during low torque operation. Allowing the clutch to relieve torque at a level just greater than the transmitted, or motive, torque minimizes fatigue cycle magnitude while driving through rough terrain. This may extend the fatigue life of components, reduces the peak load requirements on transmission components, and relieves high torques associated with power on, and power off jump landings, as well as terrain-sourced torque transients associated with heavy pedal driving through rough terrain. Although, the clutch pack 1425 of the ATM system is illustrated in FIG. 14 as being positioned directly downstream of the transmission 1404, in another example, the clutch pack 1425 of the ATM system may be positioned just upstream of the rear axle, or in yet another example the ATM system includes two separate clutch packs that may be positioned upstream of both the rear axle and the front axle respectively. In a further example, a single ATM clutch pack may be positioned upstream of the gearset that splits the transmission of power between the front and rear axles, thereby protecting from torque transients at all four tires with a single clutch pack.

In one example, the front axle (front half shafts 1426a and 1426b) is powered by a separate electric motor 1450 that is geared closer to the second (higher) gear, or driving gear if a single speed transmission is used between that motor and the front axle. At low speeds the separate or second electric motor 1450 acts as a helper for standing acceleration events. At high speed the second electric motor 1450 provides four wheel drive functionality for terrain and surface stability. This configuration allows to downsize the main prime mover 1402 (electric motor in this example), which drives the rear wheels 1422a and 1422b. This configuration will also eliminate the need for the front propeller shaft 1416 and a transmission front output gearset and associated equipment.

In another example, a high-capacity electric battery may be used as a 110V or 220V power supply by use of a power inverter 1452. Supply voltages from the power inverter 1452 may be used to run household appliances such as for example lighting, music, coffee makers, chargers, tools, etc. This configuration provides a power source without having to run a generator. Having power available to run electric appliances in a remote setting may be desirable. A battery status indicator 1454 may provide the user an instant readout of the battery charge status. The battery status indicator 1454 may be on the outside of the vehicle or be visible from outside a cabin of the vehicle. In an example, a low power mode shuts off power. In another example, the low power mode creates a warning when it detects that battery power is getting down to a level needed to get back to the starting/unload point. The starting point may be determined with the use of sensor data from the global positioning satellite system sensor. An automated algorithm stored in memory 1411 that is executed by the controller 1410 may be used to provide the warning based on the starting/unload point. In another example, the starting point may be manually selected by a user.

In another example, the controller 1410 of vehicle 1400 is configured to monitor for wheel slip by measuring wheel speed and wheel acceleration as well as using data from an onboard array of vehicle accelerometers (sensors 1412). In one embodiment, the sensors 1412 include an inertial monitoring unit (IMU).

In an example where prime mover 1402 is an electric motor, traction control

functionality may be achieved because of the fast torque response and reverse torque capabilities. When wheel slip is detected by the controller 1410, the prime mover 1402 can quickly drop or even reverse torque to mitigate the wheel slip in an embodiment.

For remote multi-day trips or for an emergency few miles of use, embodiments allow for the vehicle 1400 to be flat towed by another vehicle to charge the battery 1408 via regeneration. This may be referred to as a tow-to-charge mode.

Further in another example, the controller 1410 is configured to implement a hill decent mode control. In an embodiment with a regeneration mode on, the driver uses the pedal or brake to set vehicle descent speed. When a driver removes an input, the instantaneous speed becomes the new descent speed target. Descent control occurs via regeneration process by the prime mover and serves to charge the battery 1408. Any descent control torque generated by the prime mover 1402 serves to charge the battery 1408 in this example.

### EXAMPLE EMBODIMENTS

Example 1 includes a transmission for a vehicle. The transmission includes a first engagement member, a second engagement member, and shift actuator. The first engagement member is configured to selectively couple torque between a prime mover and an output through a first gear. The second engagement member is configured to selectively couple the torque between the prime mover and the output through a second gear. The shift actuator configured to selectively activate the first engagement member and the second engagement member.

Example 2 includes the transmission of Example 1, wherein the first engagement member is one of a sprag, a dog and an active clutch.

Example 3 includes the transmission of any of the Examples 1-2, wherein the second engagement member is one of a dog, an active clutch, a plate clutch and a centrifugal clutch.

Example 4 includes the transmission of any of the Examples 1-3, wherein the shift actuator is one of a Geneva wheel actuator shifting system, a rotary actuated shift drum actuator shifting system, a linear actuated ratchet shift actuator shifting system, and a rotary actuated ratchet shift actuator shifting system.

Example 5 includes the transmission of any of the Examples 1-4, wherein the shift actuator is configured to selectively activate the first engagement member and the second engagement member in changing from one of the first gear to the second gear by closing one of the first engagement member and the second engagement member that is open so torque is simultaneously being transmitted through both a first gear path to the output that includes the first gear and a second gear path to the output that includes the second gear and then opening another one of the first engagement member and the second engagement member.

Example 6 includes the transmission of any of the Examples 1-5, wherein the transmission is one of a parallel axis shaft configuration and an epicyclical configuration.

Example 7 includes the transmission of any of the Examples 1-6, wherein at least one of the first engagement member and the second engagement member is a sprag clutch that is configured to transmit zero torque when overrunning.

Example 8 includes a vehicle. The vehicle includes at least one electric motor to generate torque, a transmission and a shift actuator. The transmission is in operational communication with the electric motor. The transmission is located between the at least one electric motor and an axle. The transmission includes a first engagement member, a second engagement member and shift actuator. The first engagement member is configured to selectively couple torque between the electric motor and an output through a first gear. The second engagement member is configured to selectively couple the torque between the electric motor and the output through a second gear. The shift actuator is configured to selectively activate the first engagement member and the second engagement member.

Example 9 includes the vehicle of Example 8, wherein the first engagement member is one of a sprag, a dog and an active clutch and the second engagement member is one of a dog, an active clutch and a centrifugal.

Example 10 includes the vehicle of any of the Examples 8-9, wherein the shift actuator is one of a Geneva wheel actuator shifting system, a rotary actuated shift drum actuator shifting system, a linear actuated ratchet shift actuator shifting system, and a rotary actuated ratchet shift actuator shifting system.

Example 11 includes the vehicle of any of the Examples 8-10, further including at least one sensor, a controller, and memory. The controller is in communication with the at least one sensor. The controller is configured to control the shift actuator based at least in part on sensor information from the at least one sensor. The memory is used to at least store operating instructions implemented by the controller.

Example 12 includes the vehicle of Example 11, wherein the controller is further configured to implement at least one of a hill assist mode, an active control management system, traction control, regeneration mode, and descent control base at least in part on the sensor information from the at least one sensor.

Example 13 includes the vehicle of any of the Examples 11-12, wherein the controller is configured to selectively activate one of the first engagement member and the second engagement to transfer torque during at least one of a regeneration mode and an engine braking.

Example 14 includes the vehicle of any of the Examples 8-13, wherein the at least one electric motor and the transmission share a same cooling system.

Example 15 includes the vehicle of any of the Examples 8-14, wherein waste heat from a cooling system of at least the transmission and the at least one electric motor is used to heat at least one of a cabin and a battery of the vehicle.

Example 16 includes the vehicle of Example 8-14, further including a cooling system configured to cool the inverter and the at least one battery.

Example 17 includes the vehicle of any of the Examples 8-16, wherein the shift actuator is configured to selectively activate the first engagement member and the second engagement member in changing from one of the first gear to the second gear by closing one of the first engagement member and the second engagement member that is open so torque is simultaneously being transmitted through both a first gear path to the output that includes the first gear and a second gear path to the output that includes the second gear and then opening another one of the first engagement member and the second engagement member.

Example 18 includes a method of changing a gear in a transmission while the vehicle is underway. The method includes dropping a motor torque to zero; removing a first driving dog from engagement; changing the speed of a prime mover to synchronize the speed of one of the first driving dog and a second driving dog to the speed of a selected driven dog moving one of the first driving dog and the second driving dog into engagement with the selected driven dog; and applying motor torque through one of the first driving dog and the second driving dog

Example 19 includes the method of Example 18, further including using a motor controller to control at least one of the motor torque and the motor speed.

Example 20 includes the method of any of the Examples 18-19 wherein synchronizing the driving dog to the incoming driven dog speed further includes one of increasing and decreasing the motor speed to the incoming driven dog speed of the driven dog.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A transmission for a vehicle comprising:
a first engagement member configured to selectively couple torque between a prime mover and an output through a first gear;
a second engagement member configured to selectively couple the torque between the prime mover and the output through a second gear; and
a shift actuator configured to selectively activate the first engagement member and the second engagement member.

2. The transmission of claim 1, wherein the first engagement member is one of a sprag, a dog and an active clutch.

3. The transmission of claim 1, wherein the second engagement member is one of a dog, an active clutch, a plate clutch and a centrifugal clutch.

4. The transmission of claim 1, wherein the shift actuator is one of a Geneva wheel actuator shifting system, a rotary actuated shift drum actuator shifting system, a linear actuated ratchet shift actuator shifting system, and a rotary actuated ratchet shift actuator shifting system.

5. The transmission of claim 1, wherein the shift actuator is configured to selectively activate the first engagement member and the second engagement member in changing from one of the first gear to the second gear by closing one of the first engagement member and the second engagement member that is open so torque is simultaneously being transmitted through both a first gear path to the output that includes the first gear and a second gear path to the output that includes the second gear and then opening another one of the first engagement member and the second engagement member.

6. The transmission of claim 1, wherein the transmission is one of a parallel axis shaft configuration and an epicyclical configuration.

7. The transmission of claim 1, wherein at least one of the first engagement member and the second engagement member is a sprag clutch that is configured to transmit zero torque when overrunning.

8. A vehicle comprising:
at least one electric motor to generate torque;
a transmission in operational communication with the electric motor, the transmission located between the at least one electric motor and an axle, the transmission including at least,
a first engagement member configured to selectively couple torque between the electric motor and an output through a first gear;
a second engagement member configured to selectively couple the torque between the electric motor and the output through a second gear; and
a shift actuator configured to selectively activate the first engagement member and the second engagement member.

9. The vehicle of claim 8, wherein the first engagement member is one of a sprag, a dog and an active clutch and the second engagement member is one of a dog, an active clutch and a centrifugal.

10. The vehicle of claim 8, wherein the shift actuator is one of a Geneva wheel actuator shifting system, a rotary actuated shift drum actuator shifting system, a linear actuated ratchet shift actuator shifting system, and a rotary actuated ratchet shift actuator shifting system.

11. The vehicle of claim 8, further comprising:
at least one sensor;
a controller in communication with the at least one sensor, the controller configured to control the shift actuator based at least in part on sensor information from the at least one sensor; and
a memory to at least store operating instructions implemented by the controller.

12. The vehicle of claim 11, wherein the controller is further configured to implement at least one of a hill assist mode, an active control management system, traction control, regeneration mode, and descent control base at least in part on the sensor information from the at least one sensor.

13. The vehicle of claim 11, wherein the controller is configured to selectively activate one of the first engagement member and the second engagement to transfer torque during at least one of a regeneration mode and an engine braking.

14. The vehicle of claim 8, wherein the at least one electric motor and the transmission share a same cooling system.

15. The vehicle of claim 8, wherein waste heat from a cooling system of at least the transmission and the at least one electric motor is used to heat at least one of a cabin and a battery of the vehicle.

16. The vehicle of claim 8, further comprising a cooling system configured to cool an inverter and at least one battery.

17. The vehicle of claim 8, wherein the shift actuator is configured to selectively activate the first engagement member and the second engagement member in changing from one of the first gear to the second gear by closing one of the first engagement member and the second engagement member that is open so torque is simultaneously being transmitted through both a first gear path to the output that includes the first gear and a second gear path to the output that includes the second gear and then opening another one of the first engagement member and the second engagement member.

18. A method of changing a gear in a transmission while the vehicle is under way, the method comprising:
dropping a motor torque to zero;
removing a first driving dog from engagement;
changing the speed of a prime mover to synchronize the speed of one of the first driving dog and a second driving dog to the speed of a selected driven dog;
moving one of the first driving dog and the second driving dog into engagement with the selected driven dog; and
applying motor torque through one of the first driving dog and the second driving dog.

19. The method of claim 18, further comprising:
using a motor controller to control at least one of the motor torque and the motor speed.

20. The method of claim 18, wherein synchronizing the driving dog speed to the incoming driven dog speed further comprises:
one of increasing and decreasing the motor speed to the incoming driven dog speed of the driven dog.
